(19) United States
(12) Patent Application Publication
(10) Pub. No.: US 2022/0241919 A1
(43) Pub. Date: Aug. 4, 2022

(54) POWER TOOL SYSTEM

(71) Applicant: Nanjing Chervon Industry Co., Ltd., Nanjing (CN)

(72) Inventor: Zhiguo Chen, Nanjing (CN)

(21) Appl. No.: 17/728,258

(22) Filed: Apr. 25, 2022

Related U.S. Application Data
(63) Continuation of application No. PCT/CN2020/130828, filed on Nov. 23, 2020.

(30) Foreign Application Priority Data
Dec. 1, 2019 (CN) 201911209523.6
Dec. 1, 2019 (CN) 201922121041.7
Dec. 1, 2019 (CN) 201922121093.4

(51) Int. Cl. B23Q 11/00; B25F 5/02

(52) U.S. Cl. CPC B23Q 11/0071; B25F 5/02

(57) ABSTRACT

A power tool system includes a power tool, a dust collector and a clamping device. The clamping device is configured to detachably connect the dust collector to the power tool. The clamping device includes a first connection mechanism and a second connection mechanism. The first connection mechanism is configured to connect the power tool. The second connection mechanism is configured to connect the dust collector. The second connection mechanism includes a limiting assembly and a fastener. The limiting assembly is capable of clamping the dust collector and is fastened by the fastener. The second connection mechanism further includes a contact surface. When the fastener is in contact with the contact surface, a force is generated between the fastener and the contact surface, and the force is always perpendicular to the contact surface.

### RELATED APPLICATION INFORMATION

This application is a continuation of International Application Number PCT/CN2020/130828, filed on Nov. 23, 2020, through which this application also claims the benefit under 35 U.S.C. § 119(a) of Chinese Patent Application No. No. 201922121041.7, filed on Dec. 1, 2019, Chinese Patent Application No. 201911209523.6, filed on Dec. 1, 2019, and Chinese Patent Application No. 201922121093.4, filed on Dec. 1, 2019, all of which are incorporated herein by reference in their entirety.

### BACKGROUND

A power tool system includes a dust collector, a clamping device configured to clamp the dust collector to a power tool and the like. In the related art, the dust collector is often deviated from the preset direction due to complex operation and unreliable clamping of the clamping device. How to provide a power tool system that has a strong clamping force and a simple structure and is easy to operate is a technical problem to be urgently solved by those skilled in the art.

### SUMMARY

An example provides a power tool system. The power tool system includes a power tool, a dust collector and a clamping device. The dust collector is detachably connected to the power tool. The clamping device is configured to detachably connect the dust collector to the power tool. The clamping device includes a first connection mechanism and a second connection mechanism. The first connection mechanism is configured to connect the power tool. The second connection mechanism is configured to connect the dust collector. The second connection mechanism includes a limiting assembly and a fastener. The limiting assembly is capable of clamping the dust collector and is fastened by the fastener. The second connection mechanism further includes a contact surface. When the fastener is in contact with the contact surface, a force is generated between the fastener and the contact surface, and the force is always perpendicular to the contact surface.

In one example, the second connection mechanism includes a contact member. The contact member forms the contact surface. The contact surface is a spherical surface.

In one example, the second connection mechanism includes a first limiting member and a second limiting member. The first limiting member is rotatable relative to the second limiting member.

In one example, each of the first limiting member and the second limiting member is formed with a claw portion.

In one example, the body of the clamping device is formed with or connected to a rotating shaft, and the second limiting member is rotatable around the rotating shaft.

In one example, the second limiting member is formed with a connection hole into which the fastener is insertable. The connection hole is formed with an internal thread structure. The fastener is formed with an external thread structure cooperating with the internal thread structure.

In one example, the second connection mechanism further includes an elastic member. Moreover, the second connection mechanism further includes a receiving cavity configured to receive the elastic member.

In one example, the clamping device further includes a positioning member, and the power tool is formed with a positioning hole cooperating with the positioning member. The positioning member is fixedly connected to or integrated with the clamping device and is T-shaped.

In one example, the positioning member includes a connection end and a positioning end. The connection end is substantially perpendicular to the positioning end.

In one example, the dust collector includes a housing portion, an air inlet channel and a dust collection box assembly. The housing portion is formed with a receiving space. The air inlet channel is at least partially disposed in the receiving space and includes an air inlet and an air outlet. The dust collection box assembly is connected to the housing portion. The dust collection box assembly includes a base, a filter paper assembly and a dust collection box. The base is formed with or connected to a first connector and a second connector. The first connector connects the dust collection box assembly to the housing portion. The filter paper assembly filters fluid from the air inlet channel. The dust collection box is connected to the base by the second connector. When the dust collection box assembly is connected to the housing portion by the first connector and the dust collection box is connected to the base by the second connector, the first connector and the second connector are located outside the receiving space and are at least partially located outside the housing portion.

In one example, a first stopper portion is formed on the housing portion, and a second stopper portion is formed on the second connector. When the dust collection box assembly is connected to the housing portion by the first connector, the dust collection box connected to the base by the second connector is fixed to the base. The first stopper portion cooperates with the second stopper portion, and the first stopper portion and the second stopper portion are capable of preventing movement of the second connector. When the dust collection box assembly is detached from the housing portion, the first stopper portion and the second stopper portion are movable away from each other and allow the second connector to move. The second connector is operable to make the dust collection box detachable from the dust collection box assembly.

In one example, the base further includes a rotation shaft extending along a direction of a straight line. The first connector and the second connector are rotatable around the rotation shaft. The rotation shaft is provided with an elastic member configured to press the first connector and the second connector.

In one example, a receiving cavity is formed when the dust collection box is connected to the base, and the filter paper assembly is disposed in the receiving cavity.

In one example, a joint between the housing portion and the dust collection box assembly is at least partially recessed toward the receiving space.

In one example, when the dust collection box assembly is connected to the housing portion, the dust collection box assembly is at least partially covered by the housing portion.

In one example, the filter paper assembly is detachably connected to the base.

In one example, the filter paper assembly includes a filter paper and a fixing member. The filter paper is fixable into a whole by the fixing member.

In one example, the fixing member is formed with a plurality of snaps and engageable with the base.

In one example, the fixing member is a plastic member.

In one example, the dust collector includes a housing portion, an air inlet channel and a dust collection box assembly. The housing portion is formed with a receiving space. The air inlet channel is at least partially disposed in the receiving space and includes an air inlet and an air outlet. The dust collection box assembly is connected to the housing portion. The air inlet channel includes a movable tube at least partially disposed in the receiving space. The movable tube is slidable freely along a direction of a first straight line. The housing portion is provided with a non-contact switch. When the movable tube moves along the direction of the first straight line, the non-contact switch is triggered to start a dust collecting function.

In one example, the dust collector includes a control button capable of adjusting the dust collector to a trigger mode or an automatic mode.

In one example, the air inlet channel further includes a guideway portion for the movable tube to slide along.

In one example, the air inlet channel further includes a dust suction port for dust suction and a dust discharge port for dust discharge.

In one example, the air inlet channel further includes an elastic catheter disposed between the movable tube and the dust discharge port.

In one example, a fan capable of generating airflow is disposed in the housing portion.

In one example, a control panel configured to control the movement of the dust collector is disposed in the dust collector. The control panel is disposed in a plane obliquely intersecting a direction of a second straight line extending along the direction of the first straight line.

In one example, the dust collection box assembly is connected to the housing portion by a connector.

In one example, a joint between the housing portion and the dust collection box assembly is at least partially recessed toward the receiving space.

In one example, when the dust collection box assembly is connected to the housing portion, the dust collection box assembly is at least partially covered by the housing portion.

### BRIEF DESCRIPTION OF DRAWINGS

FIG. 1 is a perspective view of a power tool system;

FIG. 2 is an exploded view of the power tool system of FIG. 1;

FIG. 3 is a perspective view of a clamping device of the power tool system of FIG. 2;

FIG. 4 is an exploded view of the clamping device of the power tool system of FIG. 3;

FIG. 5 is a sectional view of the clamping device of the power tool system of FIG. 3;

FIG. 6 is a perspective view of a dust collector of the power tool system of FIG. 2;

FIG. 7 is a sectional view of the dust collector of the power tool system of FIG. 6;

FIG. 8 is an exploded view of the dust collector of the power tool system of FIG. 6;

FIG. 9 is an exploded view of the dust collector of the power tool system of FIG. 8 from another perspective;

FIG. 10 is an exploded view of a connection assembly and a base of the dust collector of the power tool system of FIG. 6;

FIG. 11 is an enlarged view of part A of the power tool system of FIG. 7;

FIG. 12 is an enlarged view of part B of the power tool system of FIG. 8;

FIG. 13 is an exploded view of a dust collection box assembly of the dust collector of the power tool system of FIG. 6; and

FIG. 14 is a section view of the dust collector of the power tool system of FIG. 6.

### DETAILED DESCRIPTION

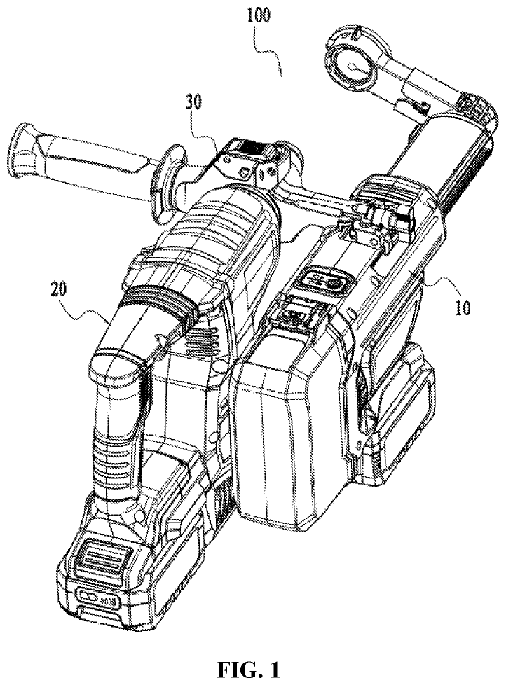

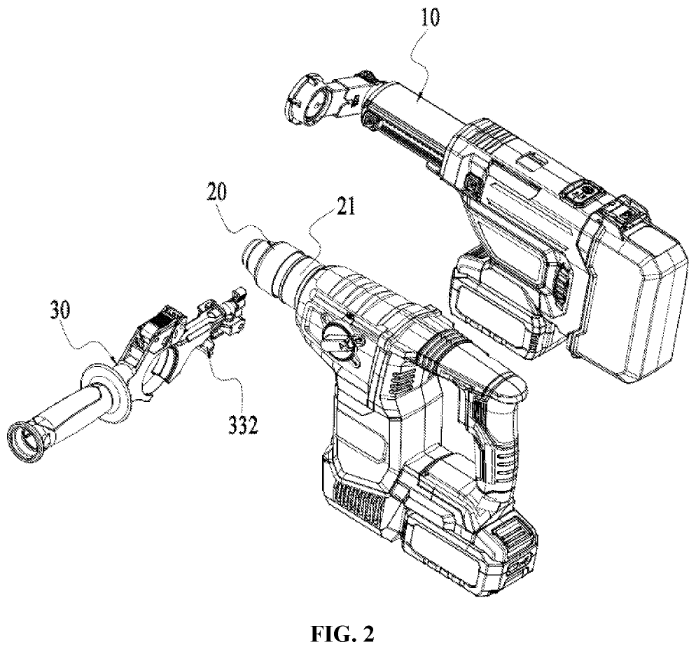

FIG. 1 and FIG. 2 show a power tool system 100. The power tool system 100 includes a dust collector 10 and a power tool 20. Moreover, the power tool system 100 further includes a connection clamping device 30 configured to connect the power tool 20 and the dust collector 10. The clamping device 30 is first connected to power and then, after being fastened, connected to the dust collector 10. The power tool 20 may be an electric hammer and can perform drilling or impact operations on a wall, a wall surface or the like. During operation, a large amount of debris and dust may be generated, seriously affecting the user experience and the operating environment. In a serious case, user operations may be affected, resulting in safety hazards. Therefore, a dust collector 10 which can operate simultaneously or independently while the electric hammer is operating is provided. The dust collector 10 has a function of adsorbing debris and dust. The clamping device 30 includes a grip 31, a first connection mechanism 32 and a second connection mechanism 33. The first connection mechanism 32 is configured to connect the electric hammer or other power tools 20. The second connection mechanism 33 is configured to connect the dust collector 10. The electric hammer includes a handle portion that can be gripped and a third connection portion 21 configured to connect the clamping device 30. In an optional implementation, the dust collector 10 may also be connected to other hammer and drill tools which may generate debris or dust or other tools.

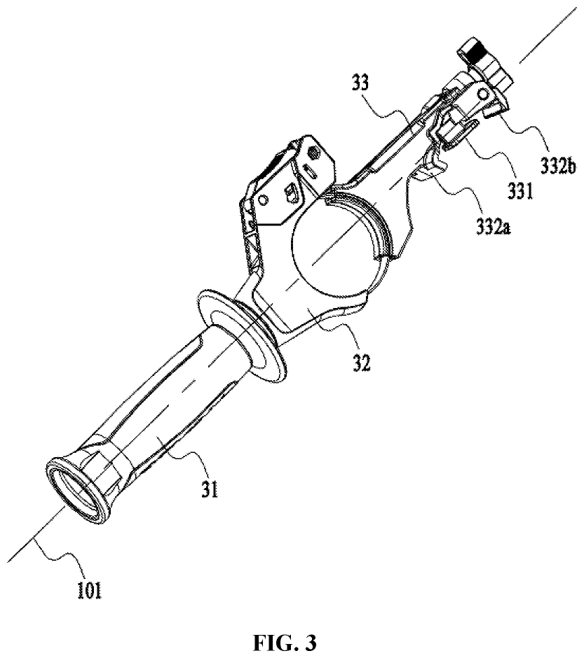

As shown in FIG. 3, the clamping device 30 extends substantially along the direction of a first straight line 101, and the first connection mechanism 32 is disposed between the grip 31 and the second connection mechanism 33. When the second connection mechanism 33 is sleeved to the third connection portion 21 of the electric hammer, the clamping device 30 can be screwed to the third connection portion 21 through rotating the grip 31. At this time, the grip 31 can be gripped by a user as a sub handle of the electric hammer. Then, the dust collector 10 is mounted to the electric hammer, the second connection mechanism 33 is engaged with a dust suction machine and adjusted to an appropriate position, and then fastening is performed.

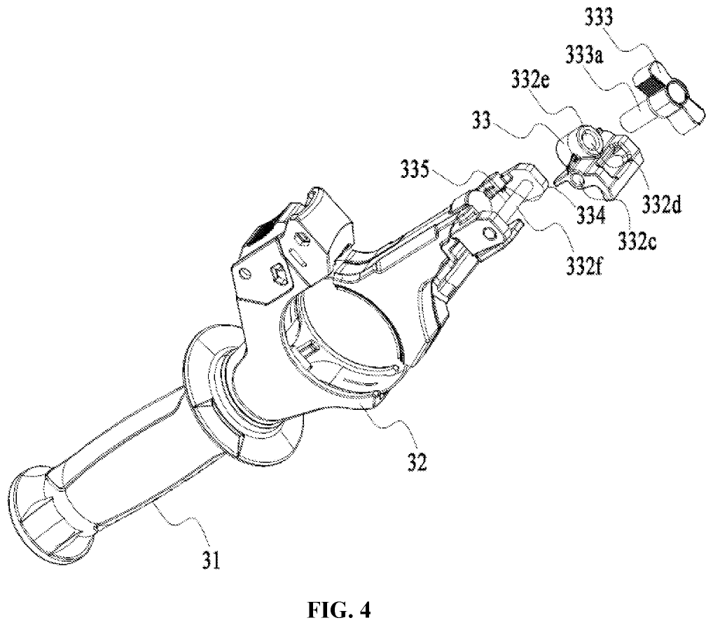

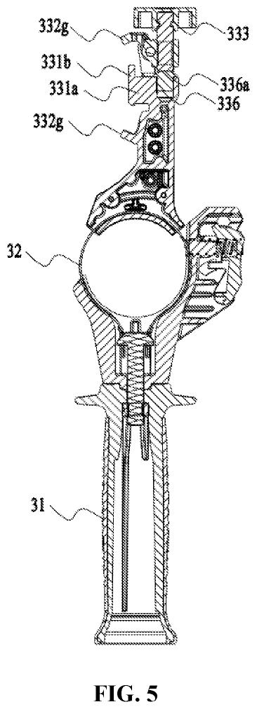

As shown in FIG. 4 and FIG. 5, the second connection mechanism 33 includes a positioning member 331, a limiting assembly 332 and a fastener 333. The second connection mechanism 33 extends from one end of the clamping device 30. The positioning member 331 is fixedly connected to or integrated with the clamping device 30 and is T-shaped. Moreover, the positioning member 331 has a connection end 331a connected to the clamping device 30 and a positioning end 331b extending from the connection end 331a. The connection end 331a is perpendicular to or intersects the first straight line 101, and the positioning end 331b is parallel to or obliquely intersects the first straight line 101. The limiting assembly 332 includes a first limiting member 332a and a second limiting member 332b. The first limiting member 332a is fixedly connected to or integrated with the body of the clamping device 30. The second limiting member 332b is rotatably connected to the body of the clamping device 30. The second limiting member 332b has a first connection hole 332c and a second connection hole 332d. The first connection hole 332c is configured to be inserted into a rotating shaft 332f, and thus the second limiting member 332b can rotate around the rotating shaft 332f. The second connection hole 332d can be inserted by the fastener 333 and is formed with an internal thread structure 332e. The fastener 333 is formed with an external thread structure 333a. When the fastener 333 is insertable into the second connection hole 332d, the second limiting member 332b is fastened to the first limiting member 332a through the cooperation of the internal thread structure 332e and the external thread structure 333a. The second connection mechanism 33 further includes a contact member 336 which cooperates with the fastener 333. The contact member 336 has a contact surface 336a on a side of the contact member 336 which is in contact with the fastener 333. The contact surface 336a is a spherical surface. Thus, when the second limiting member 332b is fixed to the first limiting member 332a by the fastener 333, the fastener 333 is in contact with the contact surface 336a which is a spherical surface so that the force between fastener 333 and each point on the spherical surface is perpendicular to the contact surface 336a. In fact, by providing the fastener 333 in contact with the spherical surface, the contact between the point and the face is achieved, and the contact between the face and the face is avoided. The direct contact between the fastener 333 and the contact face 336a is not firm due to factors such as pressing, deformation, tilting and the like between faces. With the preceding arrangement, the interaction force between the fastener 333 and the contact surface 336a is more concentrated so that the clamping force between the second limiting member 332b and the first limiting member 332a is greater. Thus, the clamping force of the clamping device 30 to the dust collector 10 is greater, and the clamping is tighter. As another implementation, it is also possible to provide a contact surface on a fastener. When the fastener is operated, the contact surface on the fastener is in contact with a contact member to achieve the contact between “point” and “face”, thereby increasing the interaction force between the contact member and the fastener.

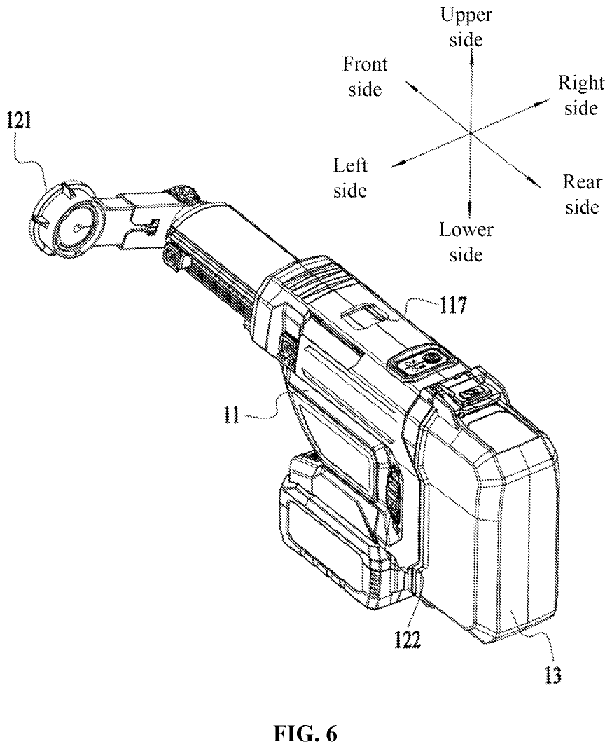

In addition, the second connection mechanism 33 is provided with a first elastic member 335, and the second connection mechanism 33 is formed with a receiving cavity 334 configured to receive the first elastic member 335. One end of the first elastic member 335 abuts the inside of the receiving cavity 334, and another end of the first elastic member 335 abuts the second limiting member 332b. In this manner, a relatively large opening is always maintained between the first limiting member 332a and the second limiting member 332b so that the dust collector 10 can be clamped quickly. When the fastener 333 fixes the second limiting member 332b to the first limiting member 332a, the elastic force of the first elastic member 335 needs to be overcome first, thereby tightening the second limiting member 332b. In fact, each of the first limiting member 332a and the second limiting member 332b is formed with a claw portion 332g. The claw portion 332g can clamp the dust collector 10 and clamp the dust collector 10 tightly under the action of the fastener 333. As shown in FIG. 6, the dust collector 10 further includes a fourth connection portion 117 cooperating with the second connection mechanism 33. The fourth connection portion 117 is formed with a positioning hole cooperating with the positioning member 331. When the dust collector 10 is mounted to the second connection mechanism 33, the positioning member 331 is first inserted into the positioning hole, and the dust collector 10 is moved along the direction of the first straight line 101 so that the dust collector 10 can be preliminarily positioned on the second connection mechanism 33 through the positioning member 331. Thus, when a user specifies the dust collector 10, a need for a user to additionally support the dust collector 10 is avoided, effectively increasing user operation convenience.

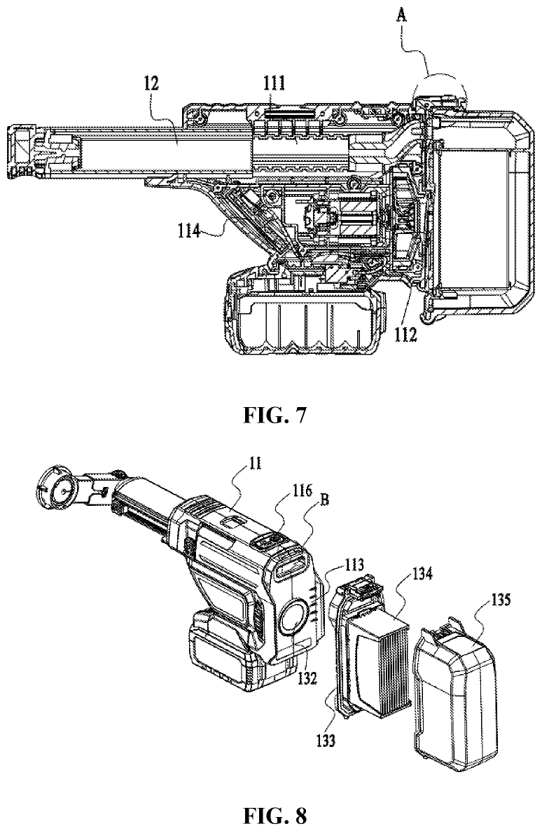

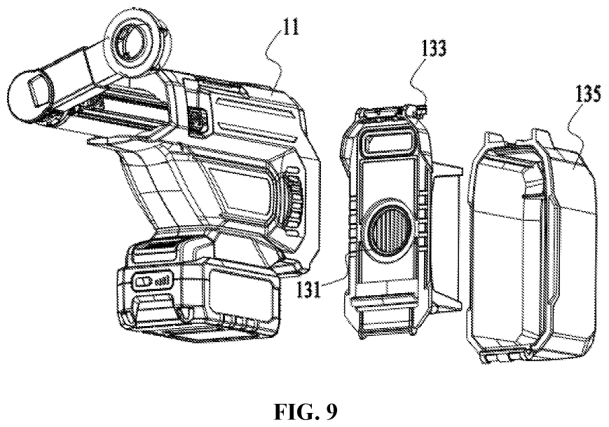

As shown in FIGS. 6 to 9, the dust collector 10 includes a housing portion 11, an air inlet channel 12 and a dust collection box assembly 13. The housing portion 11 is formed with a receiving space 111. The air inlet channel 12 is at least partially disposed in the housing portion 11 and is formed with an air inlet 121 and an air outlet 122. A fan 112 capable of generating airflow is disposed in the housing portion 11. The fan 112 operates at a high speed and can form negative pressure in the housing portion 11. Debris and dust are adsorbed through the air inlet 121 and then sent to the dust collection box assembly 13 through the air inlet channel 12. After the debris and dust are filtered through the dust collection box assembly 13, dust-free gas is discharged through the air outlet 122. The dust collector 10 further includes a coupling portion (not shown) configured to connect power supply. The coupling portion may be configured to connect a power supply device such as a battery pack. In some optional implementations, the coupling portion may also be connected to a power line or the like. To clearly explain the technical solution of the present application, the front side, rear side, left side, right side, upper side and lower side as shown in FIG. 6 are defined. The dust collection box assembly 13 of the dust collector 10 is connected to the rear side of the dust collector 10. The dust collector 10 includes a dust discharge port 132 for blowing debris and dust. The dust collection box assembly 13 is provided with a dust inlet 131 cooperating with the dust discharge port 132. In an optional implementation, the connection end 331a of the dust collector 10 employs an embedded structure for connecting the dust collection box assembly 13, that is, at least part of the dust collector 10 has grooves 113. The grooves 113 can receive at least part of the dust collection box assembly 13 so that the space inside the housing of the dust collector 10 can be effectively utilized. In fact, by optimizing the arrangement of the straps and structures inside the dust collector 10, it is possible to effectively increase the volume of the grooves 113 so that more volume of a dust collection box assembly can be embedded. In fact, the volume of the dust collection box assembly can also be increased by use of an embedded connection. Since the dust collector 10 is connected to the dust collection box assembly 13 by an embedded connection, the dust collection box assembly 13 can be made larger and longer without taking up the connection space. A control panel 114 configured to control movement of the dust collector 10 is disposed in the dust collector 10. The control panel 114 is disposed in the receiving space 111 formed in the housing portion 11 and is disposed in a plane obliquely intersecting a straight line extending along the front-rear direction, thereby further increasing the space utilization rate inside the housing portion 11.

Optionally, the dust collection box assembly 13 includes a base 133, a filter paper assembly 134 and a dust collection box 135. The filter paper assembly 134 is mounted on the base 133. The base 133 is connected to the dust collection box 135 and can form a receiving cavity for receiving the filter paper assembly 134. To facilitate the installation of the dust collection box assembly 13 to the dust collector 10, the dust collection box assembly 13 is provided with a connection assembly 136. The connection assembly 136 includes a first connector 136a configured to connect the dust collection box assembly 13 to the dust collector 10 and a second connector 136b configured to connect the dust collection box 135 to the base 133. The base 133 is provided with a rotation shaft extending along the direction of a second straight line. The first connector 136a is a latch rotating around the rotation shaft. The second connector 136b is also a latch rotating around the rotation shaft. When the dust collection box assembly 13 is fixed to the dust collector 10 through the first connector 136a, the second connector 136b cannot be triggered. In this case, the dust collection box 135 cannot be detached from the dust collection box assembly 13. Thus, users can avoid accidentally touching the connection assembly 136, which leads to the dust in the dust collection box 135 to overturn and secondary pollution. The dust collection box 135 can be detached from the dust collection box assembly 13 only when the dust collection box assembly 13 is detached from the dust collector 10. Thus, it is convenient for users to clean dust at a preset position or a specified position, thereby effectively controlling the generation of secondary pollution.

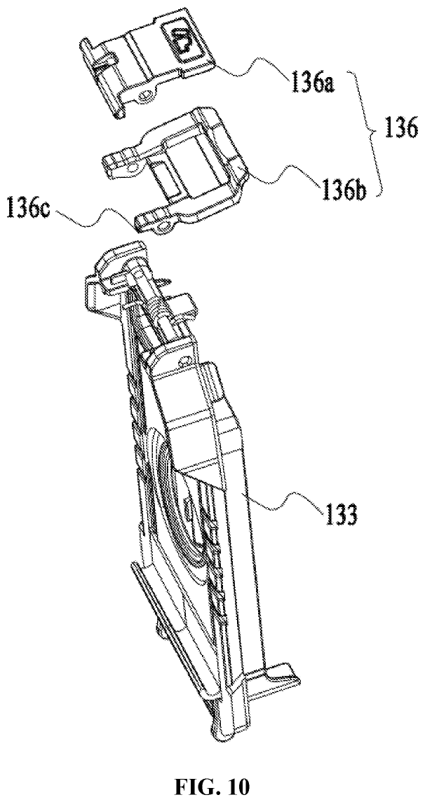

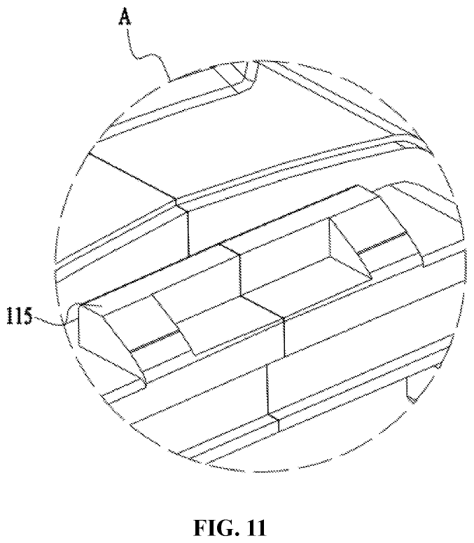

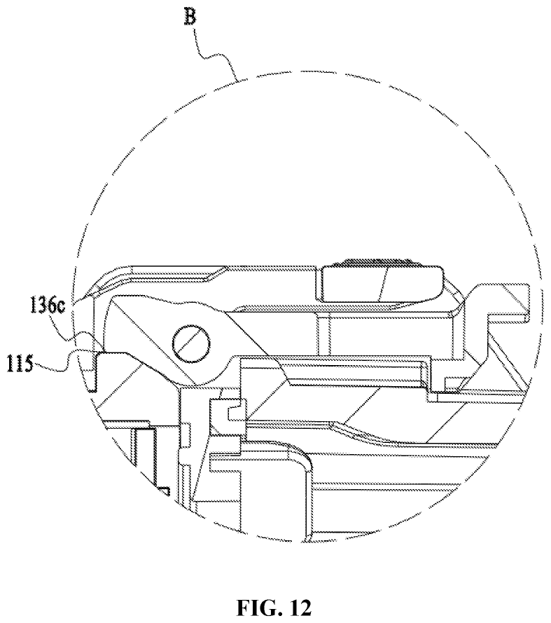

As shown in FIGS. 10 to 12, to achieve the preceding functions, the housing portion 11 of the dust collector 10 is formed with or connected to a first stopper portion 115 cooperating with the second connector 136b. Moreover, the second connector 136b is formed with or connected to a second stopper portion 136c cooperating with the first stopper portion 115. When the dust collection box assembly 13 is mounted on the dust collector 10, the first stopper portion 115 abuts against the second stopper portion 136c, and the first stopper 115 limits the rotation of the second connector 136b. In this case, the second connector 136b is always connected to the dust collection box 135 so that the dust collection box 135 cannot be detached from the dust collection box assembly 13.

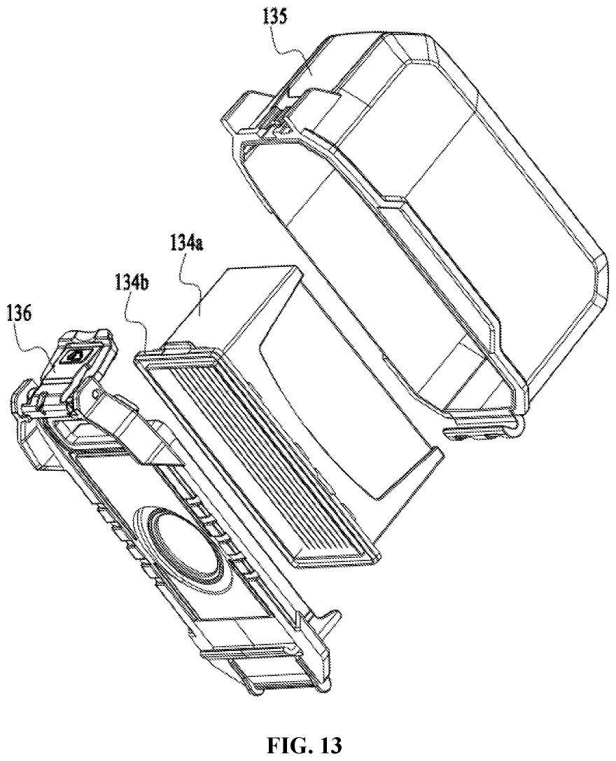

As shown in FIG. 13, the filter paper assembly 134 includes a filter paper 134a and a fixing member 134b. The filter paper 134a is fixable into a whole by the fixing member 134b. The fixing member 134b is formed with a plurality of snaps and engageable with the base 133. This effectively increases the convenience of exchanging the filter paper 134a. The fixing member 134b may be a plastic member having high strength and light weight and easily formed so that the fixing member 134b can form a plurality of snaps. In fact, the filter paper 134a has a plurality of sheets, which are separated in the natural state. The sheets need to be fixed as a whole before being mounted on the dust collection box assembly 13. By providing a plastic member, the filter paper 134a can be effectively fixed, and the strength of the filter paper 134a as a whole can be enhanced. In fact, by this arrangement, users can quickly disassemble and assemble the filter paper 134a by use of the snap structure without the need for other tools.

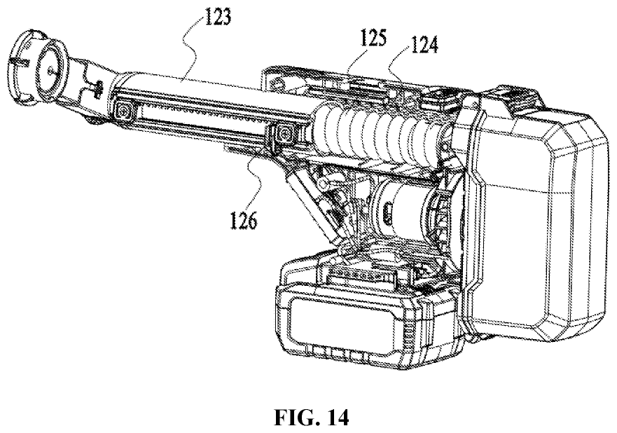

As shown in FIG. 1, FIG. 8 and FIG. 14, the dust collector 10 includes a control button 116. The control button 116 can control the dust collector 10 to switch between different modes. Exemplarily, the dust collector 10 includes a trigger mode and an automatic mode. In the trigger mode, it is necessary to trigger the dust suction port of the dust collector 10 to a preset position, thereby starting the dust suction of the dust collector 10. When the dust suction port is not triggered and away from the preset position, the dust collector 10 stops the dust suction. In the automatic mode, the dust collector 10 can always be kept in a dust-sucking state. The air inlet channel 12 of the dust collector 10 includes a movable tube 123, a guideway portion 124 and an elastic catheter 125. The movable tube 123 can slide freely along the guideway portion 124. The elastic catheter 125 is disposed between the movable tube 123 and the dust discharge port 132. The elastic catheter 125 has a pre-tightening force, can abut the movable tube 123 and push the movable tube 123 to a position farthest from the dust discharge port 132. When a hammer is operated and a workpiece such as a drill bit is drilled into the wall, the movable tube 123 biases the elastic catheter 125 and moves toward the dust discharge port 132. At this time, the movable tube 123 shortens the length exposed to the outside of the housing portion 11 of the dust collector 10 and enters the inside of the housing portion 11.

The housing portion 11 of the dust collector 10 is provided with a non-contact switch 126. The non-contact switch 126 is disposed on the sliding path of the movable tube 123 and can be triggered when the movable tube 123 slides to a preset position. The non-contact switch 126 may be a Hall switch or an optoelectronic switch. When triggered by a magnetic member on the movable tube 123, the non-contact switch 126 can transmit an electrical signal, thereby communicating with the circuit to turn on the dust suction function of the dust collector 10.

The dust collector 10 has the operation methods below.

When the control button 116 is pressed for a long time, the control circuit enters the trigger mode.

At this time, when the Hall switch of the dust collector 10 is not triggered, the dust collector 10 does not start the dust suction function. When the movable tube 123 is pressed and the Hall switch is triggered, the dust collector 10 starts the dust suction function. When the movable tube 123 is away from the non-contact Hall switch 126, the non-contact Hall switch 126 transmits another electrical signal, the circuit is disconnected, and the dust collector 10 stops collecting dust.

When the control button 116 is pressed for a short time, the control circuit can switch between the trigger mode and the automatic mode.

At this time, the dust collector 10 can be controlled into the trigger mode or the automatic mode. When the dust collector 10 is in the trigger mode, the dust collector 10 can be controlled to start the dust suction function through pressing the control button 116 for a long time. When the dust collector 10 is in the automatic mode, the dust collector 10 can be kept always in the dust-sucking state.

When the control button 116 is pressed for a long time, the control circuit is in an off state.

At this time, according to the operation of pressing the control button 116 for a short time, regardless of the mode in which the dust collector 10 is in, the dust collector 10 can be turned off after the control button 116 is pressed for a long time.

What is claimed is:

1. A power tool system, comprising:
a power tool;
a dust collector; and
a clamping device configured to detachably connect the dust collector to the power tool;
wherein the clamping device comprises:
a first connection mechanism configured to connect to the power tool; and
a second connection mechanism configured to connect to the dust collector;
wherein the second connection mechanism comprises a limiting assembly and a fastener, the limiting assembly is capable of clamping the dust collector and is fastened by the fastener, the second connection mechanism further comprises a contact surface, and a force is generated between the fastener and the contact surface and the force is always perpendicular to the contact surface when the fastener is in contact with the contact surface.

2. The power tool system according to claim 1, wherein the second connection mechanism comprises a contact member, the contact member forms the contact surface, and the contact surface is at least a part of a spherical surface.

3. The power tool system according to claim 1, wherein the second connection mechanism comprises a first limiting member and a second limiting member and the second limiting member is rotatable relative to the first limiting member.

4. The power tool system according to claim 3, wherein each of the first limiting member and the second limiting member is formed with a claw portion.

5. The power tool system according to claim 3, wherein a body of the clamping device is formed with or connected to a rotating shaft and the second limiting member is rotatable around the rotating shaft.

6. The power tool system according to claim 3, wherein the second limiting member is formed with a connection hole into which the fastener is insertable, the connection hole is formed with an internal thread structure, and the fastener is formed with an external thread structure cooperating with the internal thread structure.

7. The power tool system according to claim 3, wherein the second connection mechanism further comprises an elastic member biasing the second limiting member and the second connection mechanism further comprises a receiving cavity configured to receive the elastic member.

8. The power tool system according to claim 3, wherein the clamping device further comprises a positioning member disposed between the first limiting member and the second limiting member and the power tool is formed with a positioning hole cooperating with the positioning member.

9. The power tool system according to claim 8, wherein the positioning member comprises a connection end and a positioning end and the connection end is substantially perpendicular to the positioning end.

10. The power tool system according to claim 1, wherein the dust collector comprises:
a housing portion formed with a receiving space;
an air inlet channel at least partially disposed in the receiving space and comprising an air inlet and an air outlet; and
a dust collection box assembly connected to the housing portion;
wherein the dust collection box assembly comprises:
a base formed with or connected to a first connector and a second connector, wherein the first connector connects the dust collection box assembly to the housing portion;
a filter paper assembly configured to filter fluid from the air inlet channel; and
a dust collection box connected to the base by the second connector, wherein when the dust collection box assembly is connected to the housing portion by the first connector, the dust collection box is connected to the base by the second connector, and the first connector and the second connector are located outside the receiving space and are at least partially located outside the housing portion.

11. The power tool system according to claim 1, wherein the dust collector comprises:
a housing portion formed with a receiving space;
an air inlet channel at least partially disposed in the receiving space and comprising an air inlet and an air outlet; and
a dust collection box assembly connected to the housing portion;
wherein the dust collection box assembly comprises:
a base formed with or connected to a first connector and a second connector, wherein the first connector connects the dust collection box assembly to the housing portion;
a filter paper assembly configured to filter fluid from the air inlet channel; and
a dust collection box connected to the base by the second connector, wherein when the dust collection box assembly is connected to the housing portion by the first connector, the dust collection box is connected to the base by the second connector, and the dust collecting box cannot be detached from the base without the dust collecting box assembly being detached from the housing portion.

12. The power tool system according to claim 11, wherein the base further comprises a rotation shaft and the first connector and the second connector are rotatable around the rotation shaft.

13. The power tool system according to claim 11, wherein a receiving cavity is formed when the dust collection box is connected to the base and the filter paper assembly is disposed in the receiving cavity.

14. The power tool system according to claim 11, wherein the filter paper assembly is detachably connected to the base.

15. The power tool system according to claim 1, wherein the dust collector comprises:
a housing portion formed with a receiving space;
an air inlet channel at least partially disposed in the receiving space and comprising an air inlet and an air outlet; and
a dust collection box assembly connected to the housing portion;
wherein the air inlet channel comprises a movable tube at least partially disposed in the receiving space, the movable tube is slidable along a first straight line, the housing portion is provided with a non-contact switch, and the non-contact switch is triggered to start a dust collecting function when the movable tube moves along the first straight line.

16. A system, comprising:
a dust collector; and
a clamping device configured to detachably connect the dust collector to a power tool;
wherein the clamping device comprises:
a first connection mechanism configured to connect to the power tool; and
a second connection mechanism configured to connect to the dust collector;
wherein the second connection mechanism comprises a limiting assembly and a fastener, the limiting assembly is capable of clamping the dust collector and is fastened by the fastener, the second connection mechanism further comprises a contact surface, and a force is generated between the fastener and the contact surface and the force is always perpendicular to the contact surface when the fastener is in contact with the contact surface.

17. The system according to claim 16, wherein the second connection mechanism comprises a contact member, the contact member forms the contact surface, and the contact surface is at least a part of a spherical surface.

18. A system, comprising:
a dust collector; and
a clamping device configured to detachably connect the dust collector to a power tool;
wherein the clamping device comprises:
a first connection mechanism configured to connect to the power tool; and
a second connection mechanism configured to connect to the dust collector;
wherein the second connection mechanism comprises a limiting assembly and a fastener, the limiting assembly is capable of clamping the dust collector and is fastened by the fastener, the second connection mechanism further comprises a contact surface for contacting with the fastener, and the contact surface is at least a part of a spherical surface.
